(19) United States
(12) Patent Application Publication
(10) Pub. No.: US 2023/0144270 A1
(43) Pub. Date: May 11, 2023

(54) Container Suspension Apparatus

(71) Applicant: John Harrold Redding, Freehold, NJ (US)

(72) Inventor: John Harrold Redding, Freehold, NJ (US)

(21) Appl. No.: 17/977,266

(22) Filed: Oct. 31, 2022

Related U.S. Application Data
(60) Provisional application No. 63/276,767, filed on Nov. 8, 2021.

(51) Int. Cl. F16M 13/02; B65D 25/22

(52) U.S. Cl. CPC F16M 13/02; B65D 25/22

(57) ABSTRACT

The present disclosure may include systems for presenting, organizing, and securing collectable or stored items including drink containers. In one implementation, an apparatus is provided that includes a container securing member that has multiple container securing elements. The apparatus also includes a support member structurally connected to the container securing elements and further includes at least one mounting point for mounting to a structural support. The container securing elements span at least a diameter of a container lid, and an underside portion of the container securing elements may include various detents configured to receive and secure a container. Other related systems and methods of manufacturing are also described.

### CROSS-REFERENCE TO RELATED APPLICATIONS

This application claims priority to and the benefit of U.S. Provisional Application No. 63/276,767, entitled “Beverage Can Display Device,” filed on Nov. 8, 2021, the entirety of which is incorporated by reference herein.

### BACKGROUND

The current craft beer industry presents individuals all over the world with the opportunity to try or taste different types of hand-crafted brews and beers. Some craft brewers may not only provide a unique drink for the consumer, but may also provide a unique container for the beer or brew. For instance, in some cases, craft brewers may design cans or bottles with unique images, colors, themes, or other designs. In some cases, users may wish to display their unique craft brew containers, but may not have any way of safely and securely organizing their collection of empty containers.

### BRIEF SUMMARY

Embodiments described herein are directed to systems and apparatuses for securing, organizing, suspending, and presenting collectable items including drink containers. In one implementation, an apparatus is provided that includes a container securing member that has multiple container securing elements. The apparatus may also include a support member structurally connected to the container securing elements and may further include at least one mounting point for mounting to a structural support such as a wall. The container securing elements may span at least the diameter of a container lid. And, within the apparatus, an underside portion of the container securing elements may include various detents that are configured to receive and secure a container. Other related systems, apparatuses, and methods of manufacturing are also described herein.

In some embodiments, at least one of the container securing elements may include a protruding lip or container release tab for releasing a container in order to reposition it or exchange it with another preferred container. The protruding tab on the container securing element may be positioned opposite the mounting point on the support member. In some examples, at least one of the container securing elements may include a raised centering dome. The raised centering dome may be configured to align with a different container positioned above the first container.

In some cases, the apparatus may further include multiple additional container securing members that each include a respective plurality of container securing elements. The container securing member and the additional plurality of container securing members may be mounted to the structural support. In some embodiments, the container securing member and the additional plurality of container securing members may be mounted close enough to each other to allow a top portion of the container to be secured by the container securing element and to allow a bottom portion of the container to be secured by a different container securing element.

In some examples, the container holding member may be mounted to the structural support via a leveling strip. The leveling strip to which the container securing member is mounted may include an internal structural rib member that may provide additional support to the container securing member.

In some cases, both container securing members that hold dual container securing elements as well as mounting elements for a leveling strip may present a downward suspension on the apparatus. As such, the container securing members may be allowed to hinge or flex upward in order to allow for can or container attachment to the container securing members. In other cases, a container securing member with container securing elements may be attached to a leveling strip in a rigid orientation that minimizes upward hinging or flexing in order to securely attach the containers.

Additionally or alternatively, a system may be provided. The system may include a container securing member that has multiple container securing elements and a support member structurally connected to the container securing elements. The system may also include at least one mounting point for mounting to a structural support. The container securing elements may span at least a diameter of a container lid and, within the system, an underside portion of the container securing elements may include one or more detents configured to receive and secure a container.

In some embodiments, the container securing elements of the container securing member may include at least two concentric circular securing elements. The at least two concentric circular securing elements may include circular detents that receive and secure the container. At least one of the detents may be formed at a right angle with respect to a top portion or crimped lip of the container. In other cases, at least one of the detents may be formed at an angle that slopes upward with respect to a top portion of the container. Additionally or alternatively, at least one of the detents may be formed at an angle that slopes downward with respect to a top portion of the container.

In some cases, each of the container securing elements may include a respective protruding lip or container release tab. In some examples, each container securing element may be separately openable using the respective protruding tabs. In some embodiments, the system may be modular, allowing multiple different systems to be mounted together as part of a single unit.

Still further, a method of manufacturing may be provided. The method of manufacturing may include providing, generating, forming, or otherwise creating a container securing member that includes multiple container securing elements. The method of manufacturing may also include providing, generating, forming, or otherwise creating a support member structurally connected to the container securing elements and including at least one mounting point for mounting to a structural support. The container securing elements may span at least a diameter of a container lid, and at least an underside portion of the container securing elements may include various detents configured to receive and secure a container.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates a front view of an embodiment of a modular container suspension apparatus.

FIG. 2 illustrates a front view of an embodiment of a modular container suspension apparatus having additional elements.

FIG. 3 illustrates an embodiment of a top view of a modular container suspension apparatus.

FIGS. 4A-4D illustrate embodiments of front perspective views of a modular container suspension apparatus.

FIG. 5 illustrates an embodiment of a side view of a modular container suspension apparatus.

FIGS. 6A-6C illustrate embodiments of close-up views of different portions of a modular container suspension apparatus.

FIGS. 7A & 7B illustrate embodiments of front and top views of a leveling strip to which the modular container suspension apparatus may be mounted.

FIG. 8 illustrates a cutout side view of an accessory that may be used to connect further extensions of leveling strips.

FIG. 9 illustrates an embodiment in which multiple modular container suspension apparatuses are arranged in rows on top of each other.

FIG. 10A illustrates an embodiment of a close-up, side view of a modular container suspension apparatus.

FIG. 10B illustrates an alternative embodiment of a close-up, side view of a modular container suspension apparatus.

FIG. 11 illustrates an embodiment of a plurality of modular container suspension apparatus being used together to create a single or unified container arrangement.

FIG. 12 illustrates an embodiment of a flow diagram for a method of manufacturing a modular container suspension apparatus.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION

As will be described further below, the embodiments described herein are directed to systems and apparatuses for securing, organizing, and presenting collectable items including drink containers or other similar items. In one implementation, an apparatus is provided that includes a container securing member that has multiple container securing elements. The apparatus may also include a support member structurally connected to the container securing elements and further includes at least one mounting point for mounting to a structural support. The container securing elements may span at least a diameter of a container lid, and within the apparatus, an underside portion of the container securing elements may include various detents that are configured to receive and secure a container. Other related systems, apparatuses, and methods of manufacturing are also described herein.

Before describing the present disclosure in detail, it is to be understood that this disclosure is not limited to the specific parameters of the particularly exemplified systems, apparatus, assemblies, products, devices, kits, methods, and/or processes, which may, of course, vary. It is also to be understood that much, if not all of the terminology used herein is only for the purpose of describing particular embodiments of the present disclosure, and is not necessarily intended to limit the scope of the disclosure in any particular manner. Thus, while the present disclosure will be described in detail with reference to specific configurations, embodiments, and/or implementations thereof, the descriptions are illustrative only and are not to be construed as limiting the scope of the claimed invention.

Various aspects of the present disclosure, including devices, systems, methods, etc., may be illustrated with reference to one or more exemplary embodiments or implementations. As used herein, the terms “exemplary embodiment” and/or “exemplary implementation” mean “serving as an example, instance, or illustration,” and should not necessarily be construed as preferred or advantageous over other embodiments or implementations disclosed herein. In addition, reference to an “implementation” of the present disclosure or invention includes a specific reference to one or more embodiments thereof, and vice versa, and is intended to provide illustrative examples without limiting the scope of the invention, which is indicated by the appended claims rather than by the following description.

Furthermore, unless defined otherwise, all technical and scientific terms used herein have the same meaning as commonly understood by one of ordinary skill in the art to which the present disclosure pertains. While a number of methods, materials, components, etc. similar or equivalent to those described herein can be used in the practice of the present disclosure, only certain exemplary methods, materials, components, etc. are described herein.

It will be noted that, as used in this specification and the appended claims, the singular forms “a,” “an” and “the” include plural referents unless the content clearly dictates otherwise. Thus, for example, reference to a “column” includes one, two, or more columns. Similarly, reference to a plurality of referents should be interpreted as comprising a single referent and/or a plurality of referents unless the content and/or context clearly dictate otherwise. Thus, reference to “columns” does not necessarily require a plurality of such columns. Instead, it will be appreciated that independent of conjugation; one or more columns are contemplated herein.

As used throughout this application the words “can” and “may” are used in a permissive sense (i.e., meaning having the potential to), rather than the mandatory sense (i.e., meaning must). Additionally, the terms “including,” “having,” “involving,” “containing,” “characterized by,” as well as variants thereof (e.g., “includes,” “has,” “involves,” “contains,” etc.), and similar terms as used herein, including the claims, shall be inclusive and/or open-ended, shall have the same meaning as the word “comprising” and variants thereof (e.g., “comprise” and “comprises”), and do not exclude additional, un-recited elements or method steps, illustratively.

Various aspects of the present disclosure can be illustrated by describing components that are coupled, attached, connected, and/or joined together. As used herein, the terms “coupled”, “attached”, “connected,” “suspended”, and/or “joined” are used to indicate either a direct association between two components or, where appropriate, an indirect association with one another through intervening or intermediate components. In contrast, when a component is referred to as being “directly coupled”, “directly attached”, “directly connected,” and/or “directly joined” to another component, no intervening elements are present or contemplated.

Thus, as used herein, the terms “connection,” “connected,” and the like do not necessarily imply direct contact between the two or more elements. In addition, components that are coupled, attached, connected, and/or joined together are not necessarily (reversibly or permanently) secured to one another. For instance, coupling, attaching, connecting, and/or joining can comprise placing, positioning, and/or disposing the components together or otherwise adjacent in some implementations.

As used herein, directional and/or arbitrary terms, such as “top,” “bottom,” “front,” “back,” “forward,” “rear,” “left,” “right,” “up,” “down,” “upper,” “lower,” “inner,” “outer,” “internal,” “external,” “interior,” “exterior,” “anterior,” “posterior,” “proximal,” “distal,” and the like can be used only for convenience and/or solely to indicate relative directions and/or orientations and may not otherwise be intended to limit the scope of the disclosure, including the specification, invention, and/or claims. Accordingly, such directional and/or arbitrary terms are not to be construed as necessarily requiring a specific order or position.

To facilitate understanding, like reference numerals have been used, where possible, to designate like elements common to the figures. Furthermore, alternative configurations of a particular element may each include separate letters appended to the element number. Accordingly, an appended letter can be used to designate an alternative design, structure, function, implementation, and/or embodiment of an element or feature without an appended letter. Similarly, multiple instances of an element and or sub-elements of a parent element may each include separate letters appended to the element number.

In each case, the element label may be used without an appended letter to generally refer to instances of the element or any one of the alternative elements. Element labels including an appended letter can be used to refer to a specific instance of the element or to distinguish or draw attention to multiple uses of the element. However, element labels including an appended letter are not meant to be limited to the specific and/or particular embodiment(s) in which they are illustrated. In other words, reference to a specific feature in relation to one embodiment should not be construed as being limited to applications only within said embodiment.

It will also be appreciated that where two or more values, or a range of values (e.g., less than, greater than, at least, and/or up to a certain value, and/or between two recited values) is disclosed or recited, any specific value or range of values falling within the disclosed values or range of values is likewise disclosed and contemplated herein. Thus, disclosure of an illustrative measurement or distance less than or equal to about 10 units or between 0 and 10 units includes, illustratively, a specific disclosure of: (i) a measurement of 9 units, 5 units, 1 units, or any other value between 0 and 10 units, including 0 units and/or 10 units; and/or (ii) a measurement between 9 units and 1 units, between 8 units and 2 units, between 6 units and 4 units, and/or any other range of values between 0 and 10 units.

Various modifications can be made to the illustrated embodiments without departing from the spirit and scope of the invention as defined by the claims. Thus, while various aspects and embodiments have been disclosed herein, other aspects and embodiments are contemplated. It is also noted that systems, apparatus, assemblies, products, devices, kits, methods, and/or processes, according to certain embodiments of the present disclosure may include, incorporate, or otherwise comprise properties, features, components, members, and/or elements described in other embodiments disclosed and/or described herein. Thus, reference to a specific feature in relation to one embodiment should not be construed as being limited to applications only within said embodiment. The headings used herein are for organizational purposes only and are not meant to be used to limit the scope of the description or the claims.

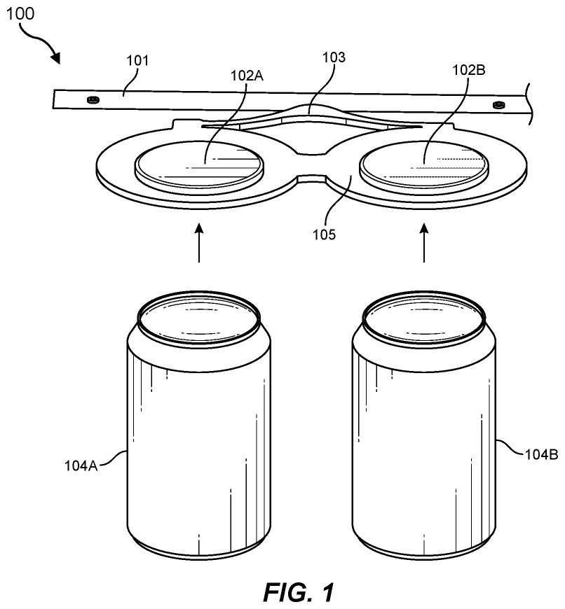

FIG. 1 illustrates an embodiment of a container suspension apparatus 100. The container suspension apparatus 100 may be configured to secure, organize, and/or present collectable items including drink containers or other items. The container suspension apparatus 100 may include a container securing member 105 that has multiple container securing elements 102A/102B. The container suspension apparatus 100 may include substantially any number of container securing elements 102A/102B, including more or less than the two shown in FIG. 1. The container securing elements 102A/102B may be linked, attached, or otherwise secured together via the container securing member 105. The container securing member 105 may span between the container securing elements 102A/102B, and may provide structural support for the container securing elements.

The container securing member 105 may ensure that the containers 104A/104B (e.g., empty beer cans) are held upright and level with respect to each other and with respect to a mounting surface. The container suspension apparatus 100 may include a support member 103 that is structurally connected to the container securing elements 102A/102B. The support member 103 may also include at least one mounting point for mounting to the mounting surface. In some embodiments, the container suspension apparatus 100 may be mounted to a structural support. The structural support may be a wall, a presentation board, a surface-mountable leveling strip 101, or other structure capable of holding up the containers. The leveling strip 101 may include various holes or mounting points to which the container suspension apparatus 100 may be mounted. These mounting points may provide flexibility in how the containers are arranged, allowing a user to mount the container suspension apparatus 100 to different parts of the leveling strip 101.

As will be explained further below, the container securing elements 102A/102B may be designed to span at least the diameter of a container lid. Thus, as can be seen in FIG. 1, each container securing element 102A/102B is wide enough to cover a beer can lid. The underside of the container securing elements 102A/102B may include various detents that are configured to receive and secure the containers 104A/104B (e.g., empty beer cans or other beverage containers). The detents allow a user to push a can (or other collectible item) up into the securing element and securely snap or secure it into position. In some cases, multiple rows of container suspension apparatuses 100 may be implemented. In such cases, once a container is placed into position within the detents of the container securing elements, the bottom portion of the can may be placed into position over an extended portion of a lower row of container securing elements. In such cases, each can may be held in place both at the top portion of the can and at the bottom portion of the can. At least in some embodiments, the method of securing or snapping the top lips of containers to the securing elements may secure and hold a lightweight or empty container in an attenuated manner that allows for future release of the can and for rearrangement of the containers in the apparatus.

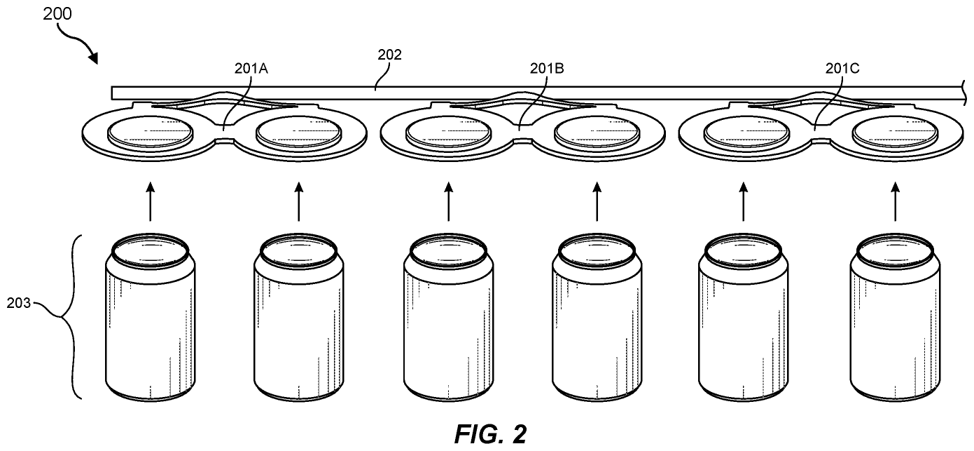

FIG. 2 illustrates an embodiment of a container suspension apparatus 200 that includes multiple container securing members 201A, 201B, and 201C, each with its own plurality of container securing elements. Each container securing member in this embodiment may be configured to hold two containers 203. In other embodiments, each container securing member 201A-201C may be configured to hold one, three, or some other higher number of containers. The container securing members 201A-201C may be mounted in rows, for example, using leveling strips 202. The containers 203 may then be inserted inside the container securing elements of the container securing members 201A-201C.

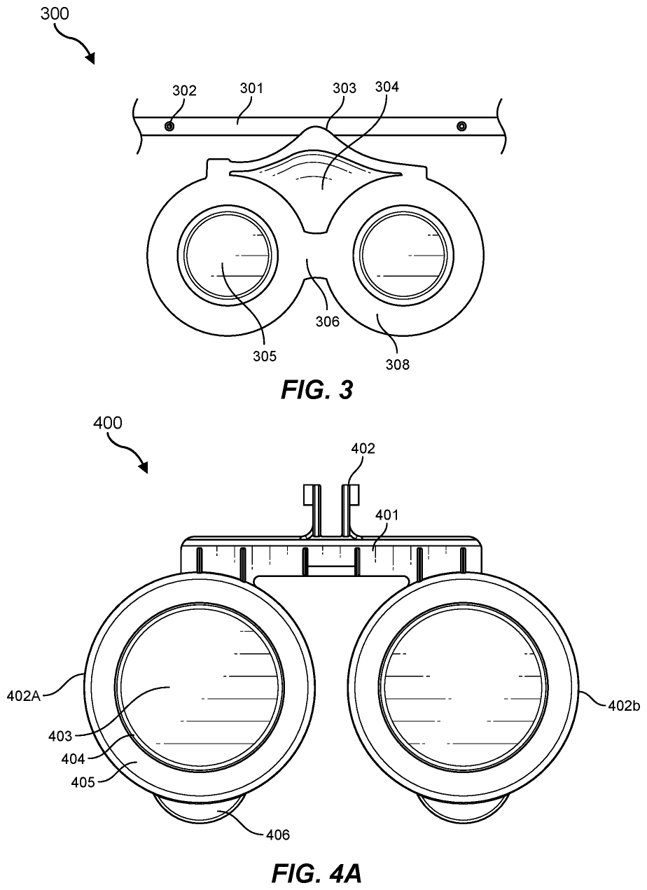

FIG. 3 illustrates a top view of a container suspension apparatus 300. The container suspension apparatus 300 may include multiple container securing elements 305. These container securing elements 305 may be structurally connected to each other at 304 and/or at 306. The support member 304 may not only connect the (two) container securing elements, but may also allow for mounting to a wall or other support structure via leveling strip 301 (e.g., that is, itself, attached to the support structure via mounting holes 302) or via some other support structure at mounting point 303. The container securing elements may be shaped in a round fashion, or may be shaped to accommodate different collectible items. The container securing elements 305 may be made of plastic, rubber, metal, wood, or other materials or compounds. At least in some embodiments, the container securing elements may be dimensioned to span at least the diameter of a beer can lid or a lid of another container or to span over a different type of object.

When attached to the leveling strip at mounting point 303, the container securing member material may be flexible and may allow the container securing member 304 to move or flex upward. This may allow a user to position the perimeter of the container securing elements to allow a tilted orientation of the containers for attachment or securing. In some cases, the container securing member 304 may be hingedly mounted to the leveling strip (or other structural support). As such, the container securing member may allow for various hinge orientations that allow the user to secure the container to the container securing elements.

In some cases, the container securing elements 305 may include raised or protruding sections and/or recessed sections. The underside of the raised sections may allow for the insertion of a can from underneath the container securing elements. The raised sections may allow for the bottom side of a different can to be placed thereon and aligned in a vertical position. These different levels may provide structural lips or latching or clasping mechanisms that are designed to hold the containers in place. In some cases, the container securing elements 305 may include grooves or indentations 308 that provide further grip and latching power when aligning a container. This grip may be designed to be sufficient to hold the can in position and align the can vertically, while still allowing a user to easily release the can reposition or replace it if desired.

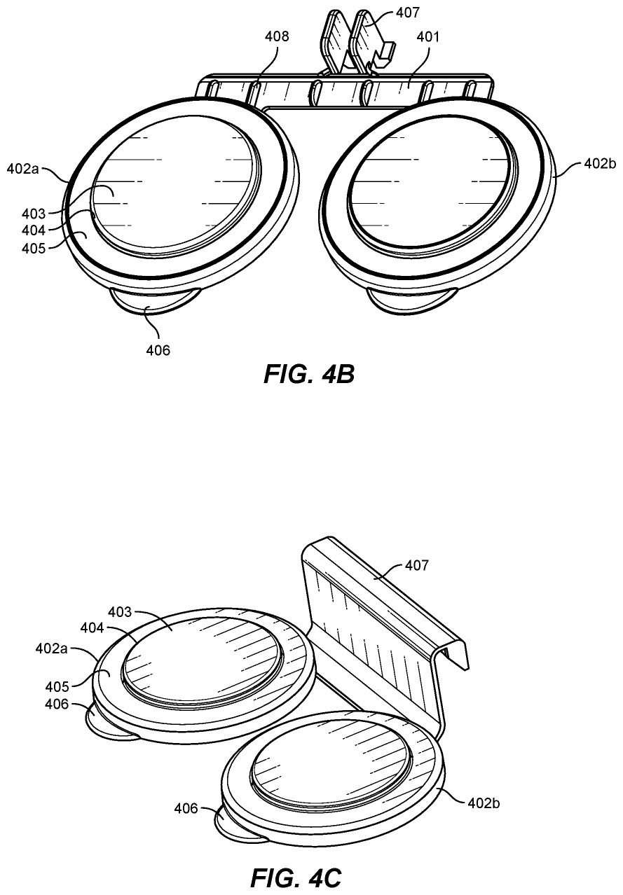

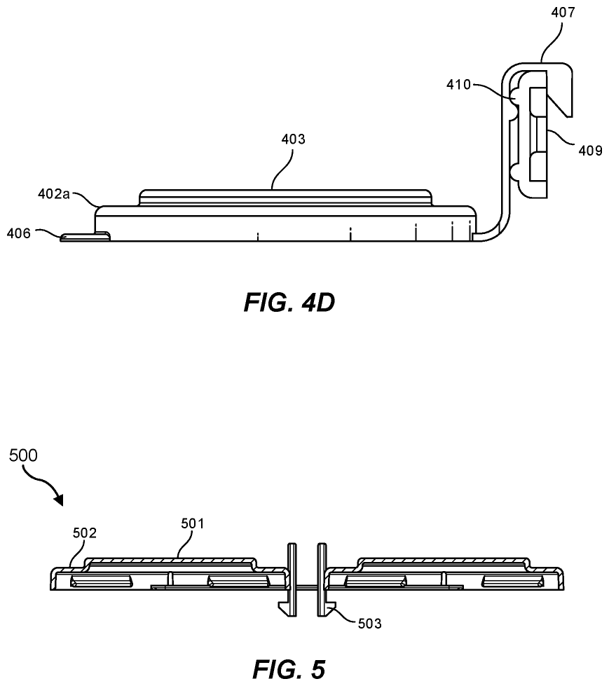

FIG. 4A illustrates an embodiment of a container suspension apparatus 400. The container suspension apparatus 400 may include multiple container securing elements 402A/402B. In this embodiment, the container securing elements 402A/402B may include protruding lips or container release tabs 406. The protruding tab 406 on the container securing element 402A, for example, may be positioned opposite the mounting point on a support member 401. Or, the protruding tab 406 may be positioned opposite from the securing detents on the underside of the container securing elements, which secure onto the crimped upper lip of the aluminum can. The protruding tab 406 may thus be placed to allow the container securing element to be detached from the container that is suspended therefrom. The protruding tab 406 may thus allow collections or displays of canisters to be changed or reorganized more easily. At least in some cases, the support member 401 may link the two container securing elements 402A/402B together and may provide a mounting mechanism 407. The mounting mechanism 407 may include clips or latches that lock into place in a leveling strip or directly into a wall or other structural support to hold the container suspension apparatus 400 in place.

The protruding container release tab 406 on the container securing element 402A may allow a user to grasp the container securing element and lift it upward or pull it downward. Using such a motion, the user may unsecure a container from the container securing element by pulling upward on the protruding tab 406, or may secure the container to the container securing element 402A by pulling up on the protruding tab 406. The container release tab may be formed in substantially any shape or design, and may stick out more or less in different embodiments relative to the respective container securing elements 402A/402B. Moreover, the protruding tab 406 may appear on the sides of the container securing elements, or in some other position than the front of the container securing elements.

As noted above, the container securing elements 402A/402B may include raised portions (e.g., 403). The raised center portion 403 may be dimensioned to slide into the hollow bottom rim of a beer or beverage container. As such, the raised center portion 403 may provide structural support for the bottom hollow portion of a container. The raised center portion 403 may be circular, or some other shape, and may be defined by a raised outer perimeter 404. In some cases, the raised center portion 403 may be defined by an architectural pattern that fits within the hollow bottom of the beverage container or can. Accordingly, the raised center portion 403 of the container securing elements may be formed using circular shapes (as shown) other decorative shapes, such as a floral or hexagonal or pentagonal or other shapes that generally remain circular enough or that have opposing dimensions that would still allow the raised center portion 403 fit within the open hollow of the underside of the beverage cans. The support surface 405 may provide structural support for the container, as the bottom rim of the container may rest on this surface.

FIG. 4B illustrates an alternative view of the container suspension apparatus 400. In this image, the raised center portion 403 may be more visible, along with the raised perimeter 404, the support surface 405, and the protruding tab 406. In this embodiment, the support member 401 may include structurally supportive raised edges 408 that may provide increased lateral strength to the support member 401. Moreover, the raised edges 408 may act as a bracing point for the outer bottom wall of each container that is secured above it. As such, while a can or beverage container is secured to the connector at its top rim, the container is stabilized and held vertically stable by both the container securing element's raised dome fitment within the can's hollow bottom and by the twin raised edges 408 that straddle the center of the lower side wall of the can as the can is suspended and aligned above the lower securing element. In this manner, the apparatus, when secured to the wall, may provide stability and proper alignment.

In some embodiments, as shown in FIG. 4C, a different type of mounting mechanism 407 may be used. The mounting mechanism 407 of FIG. 4A is a latch or snap-lock mechanism, while the mounting mechanism 407 of FIGS. 4C and 4D is a slide-over mechanism that allows a user to slide the mounting mechanism over a leveling strip or similar mounting feature 409. The mounting mechanism 407 may be designed to slide over a leveling strip at set positions or at pocketed interruptions on the strip. The mounting mechanism 407 may include an inner horizontal rib that causes the mechanism to snugly hold along the thickness of the leveling strip. In this manner, the mounting mechanism may prevent jostling or being knocked out of position, as its movement may be limited to vertical up or down movement relative to the leveling strip. In some cases, the mounting feature 409 may include multiple support features 410 that contact the slide-over mechanism 407 and hold it in place relative to the mounting feature and thus, relative to the wall.

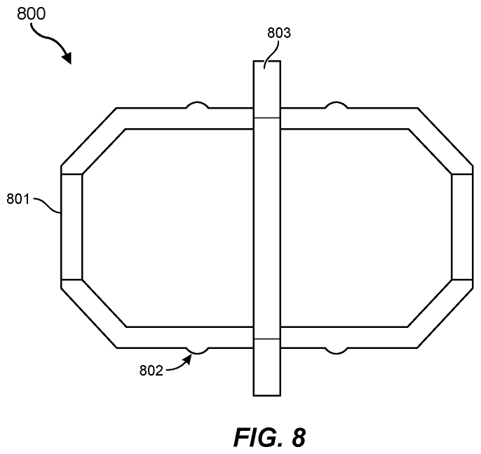

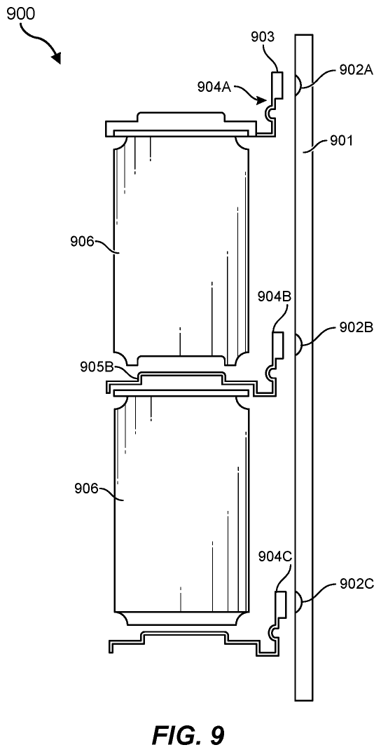

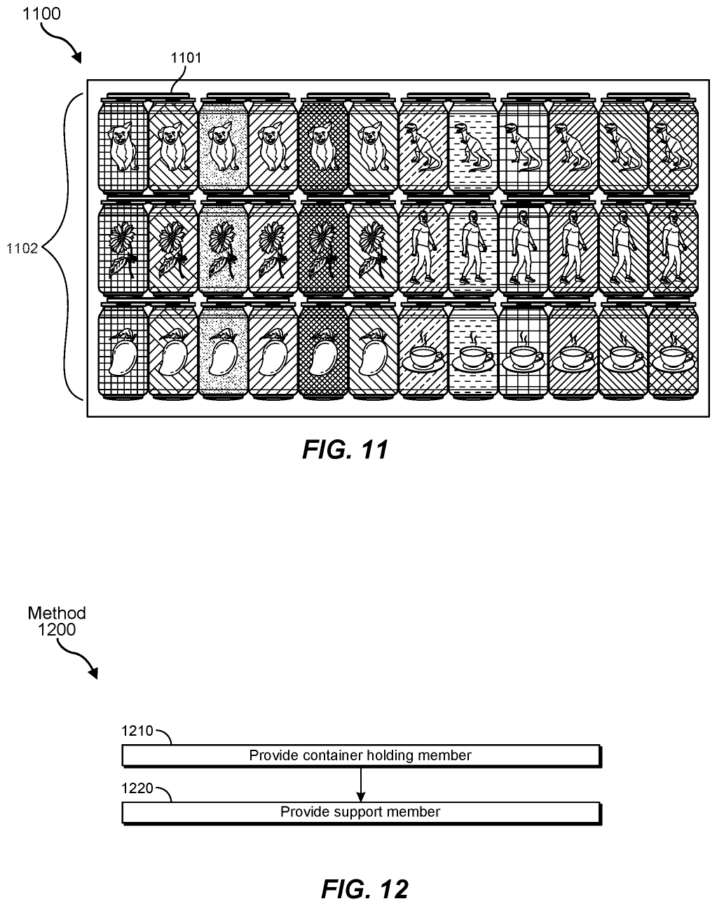

FIG. 5 illustrates a top side view of a container suspension apparatus 500. The container suspension apparatus 500 may include two container securing elements 501. In some examples, the container securing elements 501 may include a raised centering dome within the top support surface the forms the outer perimeter. The raised centering dome may be configured to align with the bottom portion of a different container positioned above the first container (as further shown in FIGS. 9 and 11). The bottom portion of the container may rest on the support surface 502. The container suspension apparatus 500 may be secured to a leveling strip (e.g., 700A or 700B of FIG. 7A or 7B, respectively) or other support structure using the clasps 503.

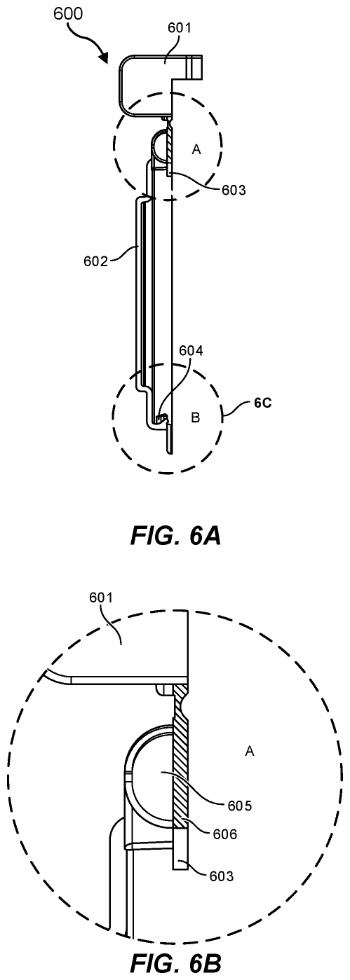

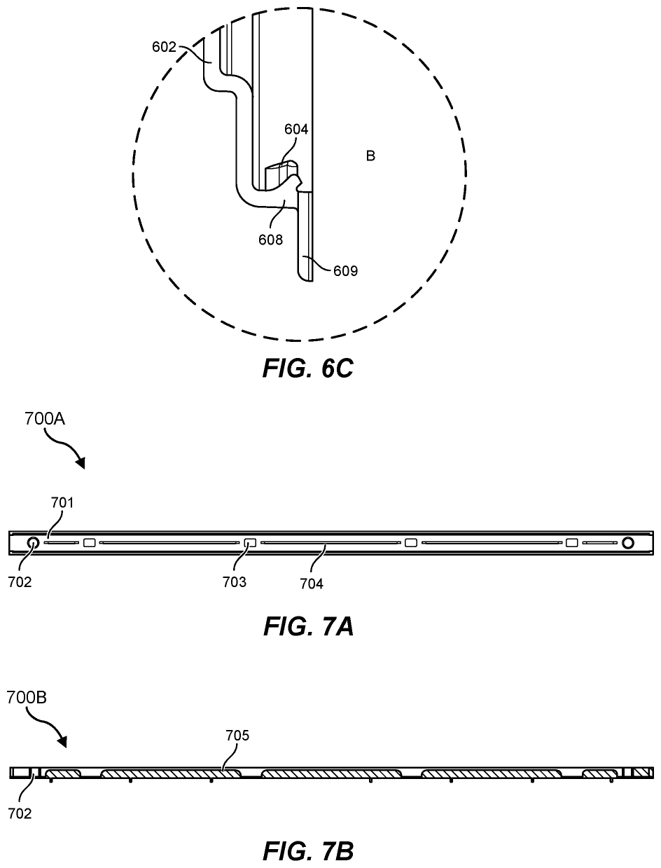

FIGS. 6A-6C provide additional details regarding the detents used in the container securing elements. For example, FIG. 6A shows a side view of a container suspension apparatus 600 that includes a fastening mechanism 601 that has a container securing element 602. The container securing element 602 may include detents 603 and 604 that may be used to secure the container in place. The container securing element 602 may include a top portion “A” and a bottom portion “B.” The A portion is shown in greater detail in FIG. 6B, and the B portion is shown in greater detail in FIG. 6C.

FIG. 6B illustrates a detent 603 that may hold a portion of a container. The container suspension apparatus 600 may also include a support member 605 that may be linked (e.g., via 606) to a fastening mechanism 601. The support member 605 may be semicircular, square, rectangular, triangular, or formed in some other shape. In some cases, the fastening mechanism 601 may be linked to the support member 605 via a hinge that allows the support member to move some number of degrees relative to the fastening mechanism 601.

FIG. 6C provides additional details regarding the detent 603. In some cases, the detent may include a protruding or extended portion 604. This extended portion 604 may extend inward toward the center of the container securing element 602. In some cases, the extended portion 604 may include a lip or an edge. This lip may extend out at an angle, or may be squared. The lip may be bulbous in shape, or may have a curved shape that curves upward, curves downward, or slopes to a rounded or pronounced edge. This lip may provide additional support for the container, helping to hold the container in place. The extended portion 604 may be in addition to or an alternative to the extended portion 608 that extends inward toward the center of the container securing element 602. The extended portion 608 may also slope inward and culminate in a rounded or pointed tip that may further support the weight of the container. The extended portion 608 may abut the protruding lip 609 that may be similar to or the same as the container release tab 406 of FIG. 4A.

FIGS. 7A and 7B illustrate examples of a mounting strip 700A/700B that may be used in conjunction with the container suspension apparatuses described herein. The mounting strips 700A/700B may include underlying support structures 701, along with different mounting holes 702. These mounting holes may be implemented to mount the mounting strips to a wall or other surface. The mounting strips 700A/700B may further include different mounting points 703 to which the container suspension apparatuses may be mounted. In some cases, these mounting points 703 may be stationary and, in other cases, the mounting points may be adjustable along a track 704. In some cases, as shown in FIG. 7B, the mounting strip may include cutout portions 705 that allow for clips, latches, or other fastening mechanisms to lie flush relative to the mounting strip.

FIG. 8 illustrates an embodiment of a leveling strip coupler 800 that has an outer structural component 801 along with an inner structural rib 803 that may provide additional structural integrity and aesthetic appeal when aligning multiple leveling strips along a mounting surface. Still further, outer nubs 802 may be provided to lock the leveling strip coupler 800 into position once properly situated or inserted into the end slots of the leveling strips. In some cases, multiple leveling strips may be mounted together in a row. The alignment of multiple leveling strips in a row may be structurally enhanced by the use of leveling strip couplers to connect one leveling strip end to another.

FIG. 9 illustrates an embodiment 900 that includes two rows of containers 906. This embodiment 900 shows a side view of a container suspension apparatus that may include different component parts. Indeed, the container suspension apparatus may be modular and may be expanded to include substantially any number of container securing members 904A/904B/904C and substantially any number of container securing elements 905A/905B. Each container securing member (e.g., 904A) may be mounted to a wall 901 or other structural support at different mounting points 902A-902C. Each container securing element may be connected to one or more other container securing elements 905A/905B via a support member 903. That support member may include a mounting point for mounting to the wall 901 (or to a horizontally-mounted mounting strip, not shown). The support member may provide a rigid, flexural, or hinging means of orienting the connectors into position to secure the containers for presentation.

In some cases, the top raised dome portion (e.g., 905B) of the securing apparatus may fit snugly or loosely into the central bottom hollow of cans or containers positioned in an above row of secured containers. Whilst the detents of the container securing elements hold the top rims of cans or containers securely, the raised dome above the securing elements 905B may further orient with or align the can(s) or rows of containers above when the raised dome is positioned directly beneath the bottom hollow of the cans or containers.

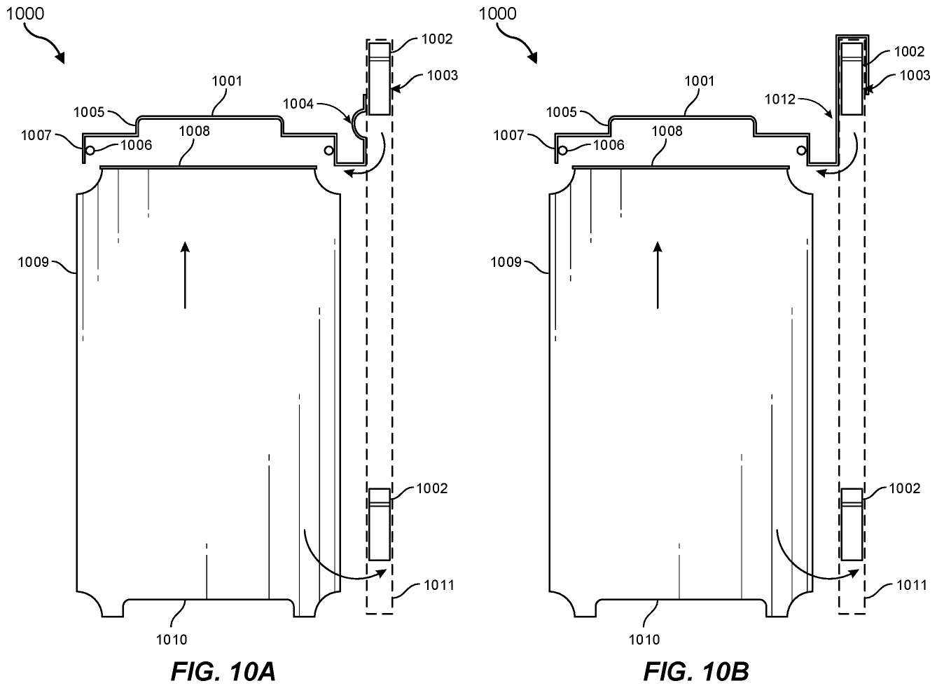

FIG. 10 illustrates an embodiment 1000 of a single container 1009 being inserted into place into a container securing element 1001. The upper lip or ring 1008 of the container 1009 may be inserted into the bottom portion 1007 of the container securing element 1001, and may be held in place via one or more detents 1006. The upper portion 1005 of the container securing element 1001 may fit snugly into the bottom portion of a different container (not shown). The support member 1004 may connect to various fastening mechanisms 1002 or 1003 in the wall 1011 or to a wall-mounted leveling strip.

In some cases, the support member 1004 may be hingedly connected to the wall 1011 or leveling strip and, as such, may hinge or flex relative to the wall or leveling strip, allowing the support member (and the container securing element 1001) to rotate out away from the wall and toward a user, potentially making it easier for the user to insert the container 1009 into the container securing element 1001. Once secured thereto, the support member 1004 may be rotated back down toward the wall and, in cases where multiple rows of such apparatuses are used, the bottom portion 1010 of the container may slip over and fit into position over the top raised dome portion of a different container securing element. Alternatively, the support member 1004 may be a rigid structure affixed firmly to the wall or leveling strip. In such cases, containers may be added to or removed from the container securing elements without rotating or bending the support member 1004. In either embodiment, although not shown, protruding tabs (such as 406 of FIG. 4A) may be implemented to lift the container securing elements to slide cans in and out of the detents 1006. FIG. 10B may be similar to FIG. 10A, except that a different type of container securing member may be used. Indeed, the container securing member 1012 may be shaped and structured like that of the slide-down mechanism 407 of FIGS. 4C and 4D.

When multiple container suspension apparatuses are implemented in a grid pattern, for example, they may appear as shown in embodiment 1100 of FIG. 11. FIG. 11 shows multiple empty beer cans 1102, arranged neatly in three rows, presenting an organized and secure view of many different unique collected cans 1101. Each can is held in place via the above-described hardware components. Cans may be added or removed as needed, and can be rotated to show a desired side. Thus, a container holding apparatus may include multiple additional container securing members that each include their own respective container securing elements. In some cases, as shown in FIG. 11, the container securing member and the additional rows of container securing members may be mounted close enough to each other to allow a top portion of the container to be secured by the container securing element and to allow a bottom portion of the container to be secured by a different container securing element, in a grid-based, row/column fashion.

FIG. 12 illustrates a method of manufacturing 1200. The method of manufacturing 1200 may include providing, generating, forming, creating, or otherwise producing a container securing member that includes multiple container securing elements (step 1210). The method of manufacturing may also include providing, generating, forming, creating, or otherwise producing a support member structurally connected to the container securing elements and including at least one mounting point for mounting to a structural support (step 1220). These steps may be performed by any suitable manufacturing components or equipment. In some cases, these manufacturing steps may be controlled by software code and/or hardware or firmware controllers. These controllers and this code may operate to control the manufacturing process, and may carry out the steps 1210 and 1220. The container securing elements produced by these steps may span at least a diameter of a container lid, and at least an underside portion of the container securing elements may include detents that are configured to receive and secure a container such as a beer can. Additionally or alternatively, the method of manufacturing 1200 may produce a surface-mounted leveling strip to which the aforementioned components may be mounted.

In some embodiments, the method of manufacturing 1200 may produce a system. The system may include a container securing member that has multiple container securing elements and a support member structurally connected to the container securing elements. The system may also include at least one mounting point for mounting to a structural support. The container securing elements may span at least a diameter of a container lid and, within the system, an underside portion of the container securing elements may include one or more detents configured to receive and secure a container.

In some embodiments, the container securing elements of the container securing member may include at least two concentric circular securing elements. These concentric circular securing elements may be circular detents that receive and secure the container. At least one of the detents may be formed at a right angle with respect to a top portion of the container (e.g., the top rim of a beer can). In other cases, at least one of the detents may be formed at an angle that slopes upward with respect to a top portion of the container. Additionally or alternatively, at least one of the detents may be formed at an angle that slopes downward with respect to a top portion of the container (e.g., as shown in FIG. 6C).

The system architectures described herein may include a plurality of independent components that each contribute to the functionality of the system as a whole. This modularity allows for increased flexibility when approaching issues of platform scalability and, to this end, provides a variety of advantages. Individual components can be expanded incrementally as business needs dictate. Modular development also translates to decreased time to market for new functionality. New functionality can be added or subtracted without impacting the core system.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

I claim:

1. An apparatus, comprising:
a container securing member that includes a plurality of container securing elements; and
a support member structurally connected to the plurality of container securing elements and including at least one mounting point for mounting to a structural support,
wherein the container securing elements span at least a diameter of a container lid, and
wherein an underside portion of the container securing elements includes one or more detents configured to receive and secure a container.

2. The apparatus of claim 1, wherein at least one of the container securing elements includes a protruding container release tab.

3. The apparatus of claim 2, wherein the protruding container release tab on the container securing element is positioned at a forward detent position that is opposite the structural support.

4. The apparatus of claim 1, wherein at least one of the container securing elements includes a raised centering dome.

5. The apparatus of claim 4, wherein the raised centering dome is configured to align with a different container positioned above the container.

6. The apparatus of claim 1, further comprising a plurality of additional container securing members that each include a respective plurality of container securing elements.

7. The apparatus of claim 6, wherein the container securing member and the additional plurality of container securing members are mounted to the structural support.

8. The apparatus of claim 7, wherein the container securing member and the additional plurality of container securing members are mounted close enough to each other to allow a top portion of the container to be secured by the container securing element and to allow a bottom portion of the container to be aligned by a different container securing element.

9. The apparatus of claim 1, wherein the container securing member is secured to a surface-mountable a leveling strip.

10. The apparatus of claim 9, wherein the leveling strip to which the container securing member is mounted includes an internal structural rib member.

11. A system, comprising:
a container securing member that includes a plurality of container securing elements; and
a support member structurally connected to the plurality of container securing elements and including at least one mounting point for mounting to a structural support,
wherein the container securing elements span at least a diameter of a container lid, and
wherein an underside portion of the container securing elements includes one or more detents configured to receive and secure a container.

12. The system of claim 11, wherein the container securing elements of the container securing member comprise at least two concentric circular securing elements.

13. The system of claim 12, wherein the at least two concentric circular securing elements comprise circular detents that receive and secure the container.

14. The system of claim 11, wherein at least one of the detents is formed at a right angle with respect to a top portion of the container.

15. The system of claim 11, wherein at least one of the detents is formed at an angle that slopes upward with respect to a top portion of the container.

16. The system of claim 11, wherein at least one of the detents is formed at an angle that slopes downward with respect to a top portion of the container.

17. The system of claim 11, wherein each of the container securing elements includes a respective protruding container release tab.

18. The system of claim 17, wherein each container securing element is separately openable using the respective protruding container release tabs.

19. The system of claim 11, wherein the system is modular, allowing a plurality of systems to be mounted together as part of a single unit.

20. A method of manufacturing, comprising:
providing a container securing member that includes a plurality of container securing elements; and
providing a support member structurally connected to the plurality of container securing elements and including at least one mounting point for mounting to a structural support,
wherein the container securing elements span at least a diameter of a container lid, and
wherein an underside portion of the container securing elements includes one or more detents configured to receive and secure a container.
